(19) United States
(12) Patent Application Publication
(10) Pub. No.: US 2007/0094135 A1
(43) Pub. Date: Apr. 26, 2007

(54) Text and multimedia messaging payment method

(76) Inventors: Jeffrey C. Moore, Seattle, WA (US); Ian Eisenberg, Seattle, WA (US); Ronald P. Erickson, Seattle, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/255,570

(22) Filed: Oct. 21, 2005

(51) Int. Cl. G06Q 40/00

(52) U.S. Cl. 705/40; 705/53; 705/67

(57) ABSTRACT

Described is a system that relates to purchases of and/or access to remotely located goods, services and information in general, such as through the Internet or by mobile phone devices, including chat services, dating services, matchmaking services, meeting services, access to games and other executable products, access to wallpaper displays and ringtones for phones, news of any type, sports, gaming and betting, weather reports, and in general any and all services, goods and information which may be provided by a telephone device, the Internet or by any means, and which may be paid for by way of text and/or multimedia messaging.

### TECHNICAL FIELD

The present invention relates to a wireless text and/or multimedia messaging-based payment method, product and system for the receipt and/or access to remotely located goods, services and information.

### BACKGROUND INFORMATION

Access to and purchases of remotely located services, goods and virtually any type of information has exploded in recent years with the advent of Internet access and more recently through mobile telephone devices which are Short Message Service (“SMS”) and/or Multimedia Service (“MMS”) enabled. SMS text messaging is an integrated messaging service that provides the ability to send and receive text messages globally to and from other SMS enabled devices, such as mobile telephones. The system is supported by the Global System for Mobiles (GSM) and other mobile connection systems. Using the SMS, a message may be transmitted composed of up to 160 characters of any kind of text in length, and can comprise any combination of words, numbers, alphanumerics, punctuation symbols, or messages may also be in non-text, such as binary.

SMS text messages are said to be similar to paging systems, except that the delivery of messages does not require a mobile phone to be active or even within range. Messages are not sent directly to the recipient, but instead are sent to a recipient via a network SMS center (SMSC) and there they are held until the intended recipient's phone becomes active or within range. SMS messages, therefore, are advantageous in that they can always be counted on to eventually reach the intended recipient.

Another feature of SMS messaging is that the sender of a text message can receive confirmation of delivery, or otherwise notification of whether a text message has been delivered. Several short messages may also be strung together in concatenated form. Various service providers offer different uses for the SMS system, such as a bulk SMS system which can be incorporated into an existing messaging system and used to automate and/or send personalized text messages to local, regional or global recipients. Some applications of this method include peer-to-peer messaging, SMS marketing, alerts, info-text, web-to-mobile content and various notifications. An SMS gateway system is said to provide developers and integrators access to secure, reliable, international, high capacity messaging platforms with the potential to design and deploy an array of mobile data applications through any of several APIs via protocols such as SMPP, HTTP/S, FTP, XML, COM Object and the like. As can be seen, SMS text messaging is hugely popular and is used extensively, and has also been incorporated into existing CRM, e-mail and accounting systems with many more expansive applications under development and constantly being reported. SMS text messaging provides not only a convenient means for world-wide person-to-person private messaging, but also has provided a powerful business tool for discretely sending and receiving many types of information useful in business transactions, including sensitive banking information and the like. Merchant use of SMS messaging and its many advantages has not yet been fully exploited, however, with many more innovative and effective uses of this mode of information, goods and services transmission may yet be possible.

MMS multimedia messaging, the progeny of SMS protocol, allows the ability to send multimedia messages comprising pictures, images, animations, graphics and audio, in addition to text messages, to MMS enabled mobile phones. MMS messaging is, therefore, even more advantageous in its capability than SMS text messaging, and with many business and merchant vendor uses thereof not yet explored, particularly methods with respect to payment for the purchase of and/or access to goods, services and information.

### SUMMARY

In accordance with that set forth above, the present invention provides a method and product for text and/or multimedia messaging-based payment in conjunction with the purchase and/or access to remotely located goods, services and information of any kind, a system for its implementation and an array of business methods encompassing its use.

The present invention with its wide array of practical embodiments and applications will be better understood with reference to the following Detailed Description of Embodiments, taken in conjunction with the accompanying drawings.

### BRIEF DESCRIPTION OF THE DRAWINGS

FIG. 1 illustrates by way of a schematic flow diagram one embodiment of the present invention in the use of a text and multimedia messaging-based payment method and product in conjunction with a user's purchase of and/or access to remotely located goods, services and information.

FIG. 2 illustrates by way of a schematic flow diagram another embodiment of the present invention.

FIG. 3 illustrates by way of a schematic flow diagram still another embodiment of the present invention.

FIG. 4 illustrates by way of a schematic flow diagram yet still another embodiment of the present invention.

### DETAILED DESCRIPTION OF EMBODIMENTS

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware or software, or some combination thereof. In some embodiments the functions may be performed by a processor, such as a computer or an electronic data processor, in accordance with code, such as computer program code, software, and/or integrated circuits that are coded to perform such functions.

Additionally, the processing that is depicted in the drawings and described below is generally depicted as hierarchal structure for readability and understandability. Various other methodologies, such as object oriented techniques, may be preferred for various physical embodiments of the invention in order to maximize the use of existing programming technique.

One of ordinary skill in the art will appreciate that the techniques, methods and corresponding products and systems described herein may be embodied in many different forms.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in the remote purchase of and access to goods, services and information of any type.

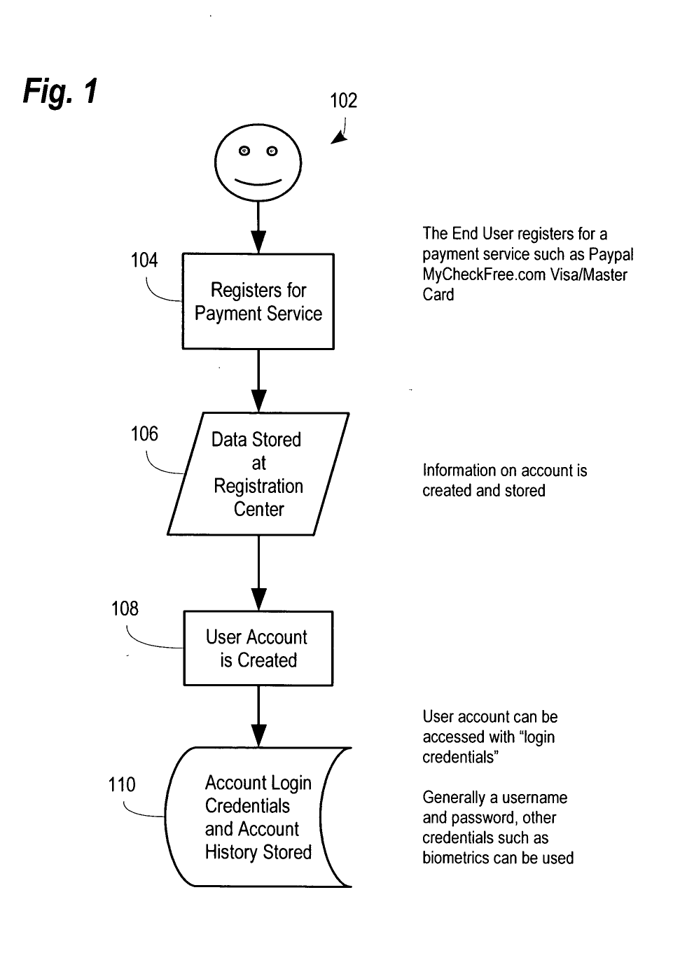

Referring now to FIG. 1, there is shown in the form of a schematic flow diagram one embodiment of an aspect of the present invention for the remote purchase of or access to various different types of services, goods and/or information as desired, for example, by way of a mobile phone device which is SMS or MMS enabled. Any conventional or non-conventional mobile phone device or equivalent is contemplated for use in the present inventive method and system, including cellular telephones from any catalog of the many mobile phone device vendors, some of which have the capability and appearance of a personal computer, or which are generally multi-functional. The inventive method and system is also contemplated for use with any mobile communication network.

The vending and purchase of, or access to, any goods, services and information which can be bought, sold or otherwise distributed by way of a telephone device or through the Internet is contemplated in conjunction with the present invention. Some non-limiting examples include, for illustration purposes only, chat services, dating services, matchmaking services, adult content services, location services, GPS services, technical support or know-how services, language learning services, tutoring or other educational services involving a limitless array of subject matter and topics, any type of professional services, such as legal services, medical services, psychiatric or psychological services, marriage counseling services and counseling services in general, gaming, gambling and handicapping services, architectural, business, real estate and accounting services, products, such as wallpaper for phone displays, phone ringtones, games, tolls, fines, music, movies, videos, computer software and all executable products, financial products, application products, design and engineering products, and search products, such as personal histories, credit histories, criminal histories, automotive and product histories, business histories, genealogies, tax payment histories, sports and player statistics and the like, weather information, any type of business information, tax information, such as new codes or regulations, legal information, such as legal notices and the like. In short, a description of goods, services and information contemplated for purchase, access to and/or dissemination in accordance with the present invention is only limited by one's imagination, and may conceivably be anything or take any form.

As shown in FIG. 1, a user may register for payment service for the purchase of, or access to, goods, services and/or information by way of a telephone call, which may be toll-free as advertised, or from a land-line or a mobile telephone device. If by mobile phone device, the user (102) may forward an SMS text message or an MMS multimedia message, to register, for example, for a payment service (104) such as Paypal, MyCheckFree.com, Visa/MasterCard, or the like. Registration data requested by a particular service and provided by the user, for example, by way of an SMS text or MMS multimedia message, is then stored at Registration Center (106), which may, for instance, be located at an SMSC or other server, either local or remote as the case may be. A user account is then created (108), with information on the account stored for current or future use. Account log-in credentials (110) may then be created to access the account, such as a user name, password, or other credentials, such as biometrics and the like, and the account history or usage history stored as well.

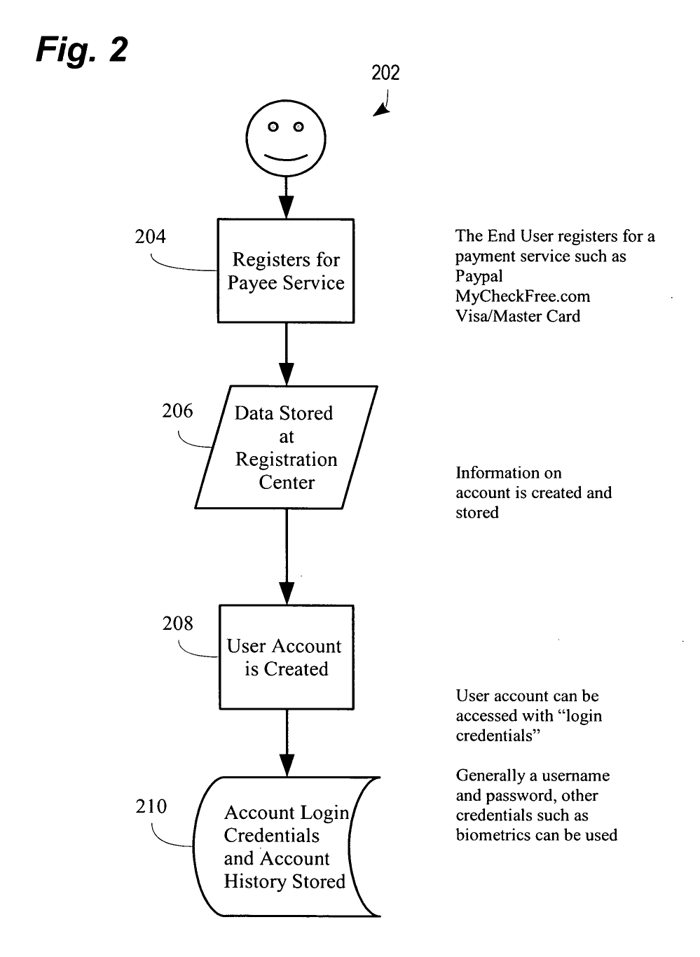

As shown in FIG. 2, there is depicted in a schematic flow diagram another embodiment of the invention in which a user (202) registers with a payee service (204), by preferably forwarding an SMS text message or an MMS multimedia message, with an entity such as Paypal, GM Capital, Visa/MasterCard, Amazon.com, or the like. User-provided information and data can then be stored at a Registration Center (206) depository, such as at a SMSC or a local or remote server. A user's account (208) is then created with applicable information and data, and user account log-in credentials (210) are then created for access to the account.

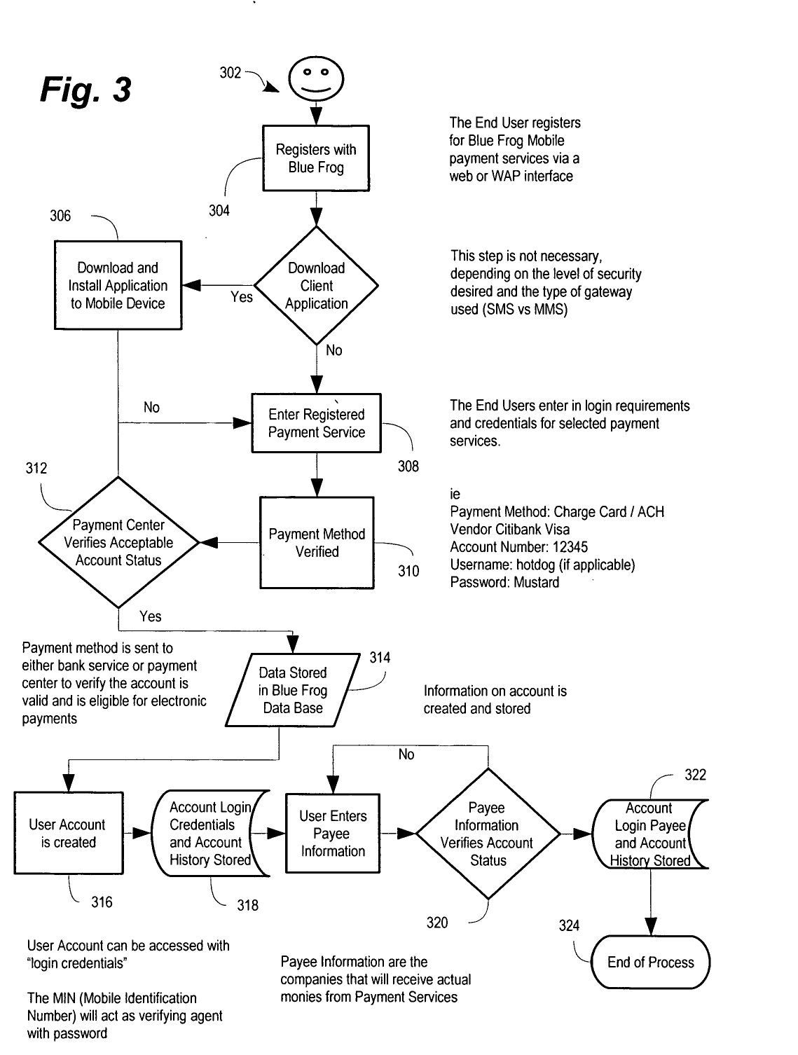

Referring now to FIG. 3, there is shown in a schematic flow diagram an embodiment of another advantageous aspect of the present inventive payment method, product and system. Here, a user (302) registers (304) for a wireless payment service to purchase goods, services and/or information, as the case may be, from a payment authority, such as Blue Frog Mobile, Inc., for example. The registration could be performed using an Internet web site, through a mobile phone device with a Wireless Application Protocol (“WAP”) interface, or perhaps by a provided toll-free number. Several options are preferable to make the system more attractive to would-be users.

Depending upon the level of security desired and the type of gateway employed, such as the SMS or MMS protocol, a client application for registration may be forwarded by an SMS or MMS text or multimedia message which can then be downloaded and installed in a user's mobile device (306). Notwithstanding this step, a user may directly enter a payment service option to be registered for use (308) by forwarding a text or multimedia message containing requested information or data for payment registration, such as required for log-in requirements and credentials for selected payment services. An example here may take the following form:
Payment Method: Charge Card/ACH
Vendor: Citibank Visa
Account No. 12345
User Name: Hotdog
Password: Mustard

The method of payment is then verified (310) and/or the required data is input into an account verifier mode where a Payment Center can verify acceptable account status (312), for example, as based upon some internal criteria, such as credit status or payment history and the like. In this step, a user's history and identification data, card data, authorization code, etc., may be routed to a bank or other account service to verify that the account is valid and current, and otherwise eligible for electronic payment.

In a next step, the collected payment registration data information, authorization codes and information and whatever required information and the like is stored in a Registration Database, or as shown here in the vendor Blue Frog's database (314). The user account may then be cleared for operation and use (316) and user log-in credentials created and issued or made available to a user. For example, a Mobile Identification Number (“MIN”) can be used as a verifying agent with a user selected password, or one generated by the vendor, as log-in credentials and stored in the system (318).

Upon use, a user, in payment for received goods, services or information, or access thereto, will log-in and enter Payee Information, such as by an SMS or MMS text or multimedia message. The “Payee” is the entity or institution that will receive transfer of currency or otherwise payment in some form from the Payment Services. The Payee Information and the user's account status are next verified as acceptable, or not (320). If acceptable, the account log-in, Payee Information and account history may be stored (322), the transaction consummated and the process ends (324).

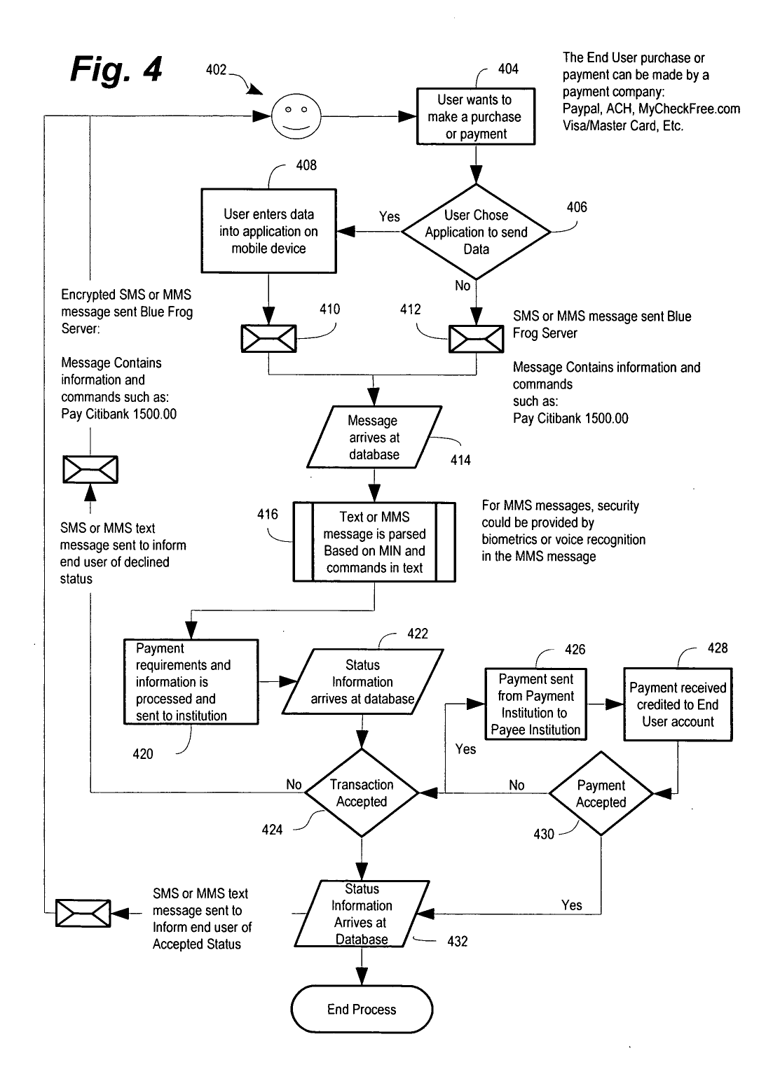

In FIG. 4, by way of a schematic flow diagram, there is depicted yet another embodiment of the present invention for an SMS or MMS text or multimedia messaging-based payment method, product and system. As shown, a user (402) desires to make a purchase or payment (404), and chooses an application to send data (406). If the user chose to install a payment-specific client application (see FIG. 3, step 306), the user enters data into the client application (408), which then creates an SMS or MMS message (410). If the user did not install the client application, the user creates the SMS or MMS message directly on the mobile phone device (412). Either way, the message may contain the requested applicable information and may also contain a command, such as, “Pay Citibank $1500.00”. The message, however created, is sent to a vendor server, here a Blue Frog Mobile server as indicated.

Next, the message arrives at a database (414), such as a storage database, and the text or multimedia message is parsed based on credentials such as the MIN of the mobile device and commands in the aforementioned text (416). For MMS messages security may be enhanced by biometrics or perhaps voice recognition capability embedded in the MMS message. Payment requirements and information is next processed and forwarded to an indicated institution (420), and status information arrives at a database (422). If the transaction is accepted (424), payment is sent from a Payment Institution to a Payee Institution (426). The payment received is credited to an end user account (428), and if the payment is accepted (430), status information as to acceptance arrives at a database (432) and an SMS or MMS text or multimedia message may be sent to the end user to inform of accept payment status, and the process ends. If the transaction was declined (424), status information as to declined status may be sent via an SMS or MMS text or multimedia message to an end user to inform of declined status, and the process ends.

While the SMS and MMS messaging protocols have been above-illustrated, other messaging protocols are also contemplated for use herein, such as the Enhanced Messaging Service (“EMS”), which is a type of halfway service between SMS and MMS, and which enables some features of MMS capability including text, some simple pictures and audio, graphics and animation.

As will be further appreciated by those persons skilled in the art, the present inventive method, product and system, inclusive of one or more embodiments of its operation through software and hardware systems, telecommunications systems and the like affords distinct business advantages not previously available to vendors and other businesses relating to marketing, sale and distribution of products, information and services. In this aspect the present invention provides advantageous and novel methods of conducting an array of typical business functions comprising, inter alia, designing, manufacturing, consulting, using, marketing, selling, licensing and/or leasing the inventive subject matter; of developing business goodwill in the use thereof; of developing valuable trademark rights in conjunction with the use thereof; and further, providing novel methods of business entity formation, such as partnerships, corporations, joint ventures, and other collaborations for the purpose of exploiting the business of the inventive subject matter.

While this invention has been described in connection with what is presently considered to be the most practical and embodiments, it is to be understood that the invention is not limited to the disclosed embodiments in any way as such are merely set forth for illustrative purposes. The present inventive method, product and system and methods of conducing business thereby are intended to cover an array of various modifications and equivalent arrangements, all of which are contemplated for inclusion within the scope and spirit of the disclosure and appended claims.

1. A method for wireless payment of remotely-located goods, services and/or information, the method comprising:
downloading and installing a client application in the mobile device;
contacting a payment means;
registering for payment with said payment means, the registration being performed by way of wireless text and/or multimedia messaging; and
conducting payment through said payment means using the client application.

2. The method of claim 1, further comprising selecting a payment option in conjunction with said payment means.

3. The method of claim 1, wherein said payment means comprises a vendor payment receiving entity.

4. The method of claim 1, wherein said payment means comprises a vendor payment receiving entity forwarding payment to a payee institution

5. The method of claim 1, further comprising receiving a return notification by text and/or multimedia messaging of accepted and/or declined payment.

6. The method of claim 1, wherein said remotely-located services, goods and/or information is a selected one or more of chat services, dating services, matchmaking services, adult content services, betting, gaming, gambling and handicapping services, technical support and know-how services, language learning, tutoring and educational services, legal services, medical services, psychiatric and psychological services, business services, architectural services, accounting services, tax services, real estate services, leasing services, renting services, buying services, private eye services, credit services, background checking services, contracting services, lobbying services, writing services, marriage counseling services, any type of counseling services, games, computer software and all executable products, phone display wallpaper, ringtones, tolls, fines, debts, music, movies, videos, financial products, application products, design and engineering products, drawings and architectural products, personal histories, product histories, credit histories, business histories, tax histories, credit histories, genealogies, criminal histories, identification histories.

7. A computer-readable medium encoded with computer-executable instructions which, when executed, perform a method for wireless payment of remotely-located goods, services and/or information, the instructions comprising:
contacting a payment means;
downloading a client application to a mobile device;
installing the client application in the mobile device;
registering for payment with said payment means, the registration being performed by way of wireless text and/or multimedia messaging; and
conducting payment through said payment means.

8. The computer-readable medium recited in claim 7, wherein the instructions further comprise selecting a payment option in conjunction with said payment means.

9. The computer-readable medium recited in claim 7, wherein said payment means comprises a vendor payment receiving entity.

10. The computer-readable medium recited in claim 7, wherein said payment means comprises a vendor payment receiving entity forwarding payment to a payee institution.

11. The computer-readable medium recited in claim 7, further comprising receiving a return notification by text and/or multimedia messaging of accepted and/or declined payment.

12. The computer-readable medium recited in claim 7, wherein said remotely-located services, goods and/or information is a selected one or more of chat services, dating services, matchmaking services, adult content services, betting, gaming, gambling and handicapping services, technical support and know-how services, language learning, tutoring and educational services, legal services, medical services, psychiatric and psychological services, business services, architectural services, accounting services, tax services, real estate services, leasing services, renting services, buying services, private eye services, credit services, background checking services, contracting services, lobbying services, writing services, marriage counseling services, any type of counseling services, games, computer software and all executable products, phone display wallpaper, ringtones, tolls, fines, debts, music, movies, videos, financial products, application products, design and engineering products, drawings and architectural products, personal histories, product histories, credit histories, business histories, tax histories, credit histories, genealogies, criminal histories, identification histories.

13. (canceled)

14. (canceled)

15. (canceled)

16. (canceled)

17. (canceled)

18. (canceled)

19. A method of conducting a financial transaction using a mobile device, comprising:
creating an SMS message at a mobile device, the SMS message including information that specifies an economic transaction, the mobile device being identified by a Mobile Identification Number (MIN);
transmitting the SMS message from the mobile device to a vendor having a database of approved customers, the approved customers being identified as customers on whose behalf the vendor is authorized to consummate economic transactions with a payment institution at which the customers have accounts, the database further including associative information that associates each approved customer with a corresponding MIN; and
receiving confirmation information that the vendor consummated the economic transaction with the payment institution, the confirmation being an acknowledgement that the vendor verified that the MIN of the mobile device corresponds to at least one approved customer in the vendor's database.
